(19) United States
(12) Patent Application Publication
(10) Pub. No.: US 2003/0080937 A1
(43) Pub. Date: May 1, 2003

(54) Displaying a virtual three-dimensional (3D) scene

(76) Inventor: John J. Light, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/003,209

(22) Filed: Oct. 30, 2001

(51) Int. Cl. G09G 5/00

(52) U.S. Cl. 345/156

(57) ABSTRACT

A method of displaying a virtual three-dimensional (3D) scene includes tracking a positional change of a head of a user with respect to a display. The method also includes transforming the virtual 3D scene in accordance with the positional change of the head, and projecting on the display a transformed virtual 3D scene.

### TECHNICAL FIELD

This invention relates to displaying a virtual three-dimensional (3D ) scene.

### BACKGROUND

A 3D scene can be displayed on a two-dimensional (2D ) screen. The user's angle of view can affect how the 3D scene is perceived. For example, a user has a viewing angle of the 3D scene with a vertex at the human eyes. If the 3D scene has a field of view with a camera position that is not the position of the eyes, the user may not perceive the 3D scene easily.

### DESCRIPTION OF THE DRAWINGS

FIG. 1 is a block diagram of a virtual three dimensional (3D ) display system.

FIG. 2 is a flowchart for displaying a virtual 3D scene.

FIG. 3 is a top view of the virtual 3D scene when a field of view and a viewing angle are not the same.

FIG. 4 is a top view of the virtual 3D scene when the field of view and the viewing angle are the same.

FIG. 5 is a top view the virtual 3D scene with a cube obscured to an observer.

FIG. 6 is a top view of the virtual 3D scene when the cube is not obscured from the observer.

FIG. 7 is a side view of another embodiment of the virtual 3D display system.

FIG. 8 is a block diagram of a computer system on which the process of FIG. 2 may be implemented.

### DESCRIPTION

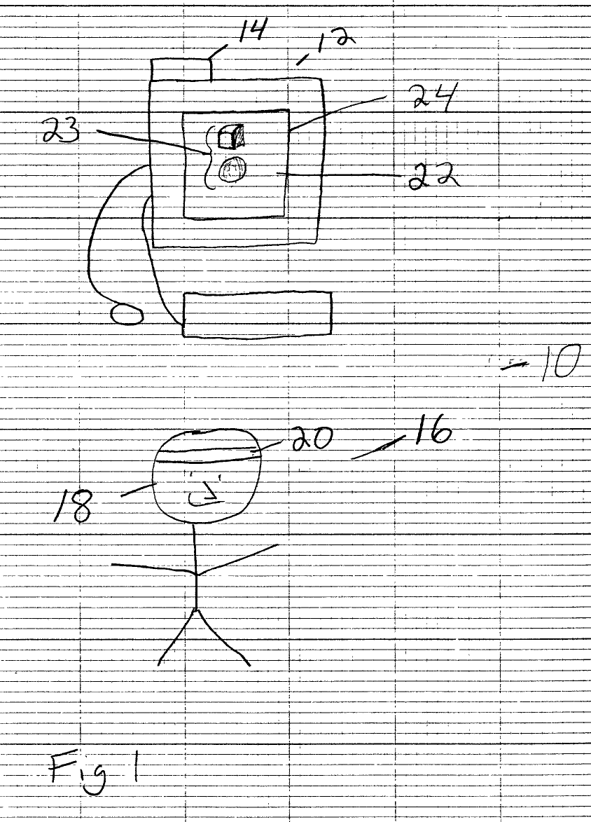

Referring to FIG. 1, a virtual three-dimensional (3D ) display system 10, includes a computer 12, a head position tracker 14, and a user 16. When a head 18 of user 16 moves, head position tracker 14 tracks the position of head 18 relative to a display 24 by following the movement of a headband 20 worn on head 18. Computer 12 displays a 3D scene 22 having objects 23 on display 24 by transforming the movements of head 18 into 3D scene 22. “Transforming” means that 3D scene 22 will be adjusted by position and orientation as head 18 moves so that 3D scene 22 looks and feels like user 16 is looking out a real-life window.

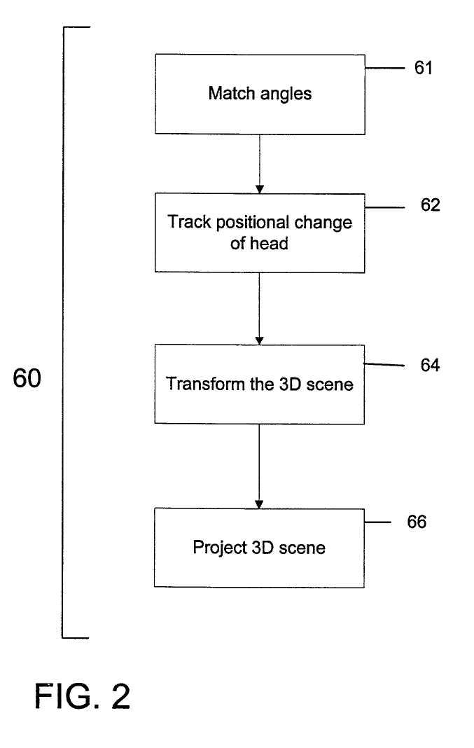

Referring to FIG. 2, a process 60 is shown for displaying virtual 3D scene 22. Process 60 displays 3D scene 22 so that it is easier for user 16 to perceive 3D scene 22 as a 3D scene. Process 60 also generates a dynamic 3D scene 22 that has two distinct features. In one feature, process 60 projects 3D scene 22 in such a way that looking at scene 22 on display 24 is similar to looking through a real-life, 3D window. In the other feature, which is different from the window-like effect, user 16 is able to magnify or expand the size of 3D scene 22 with movements of head 18.

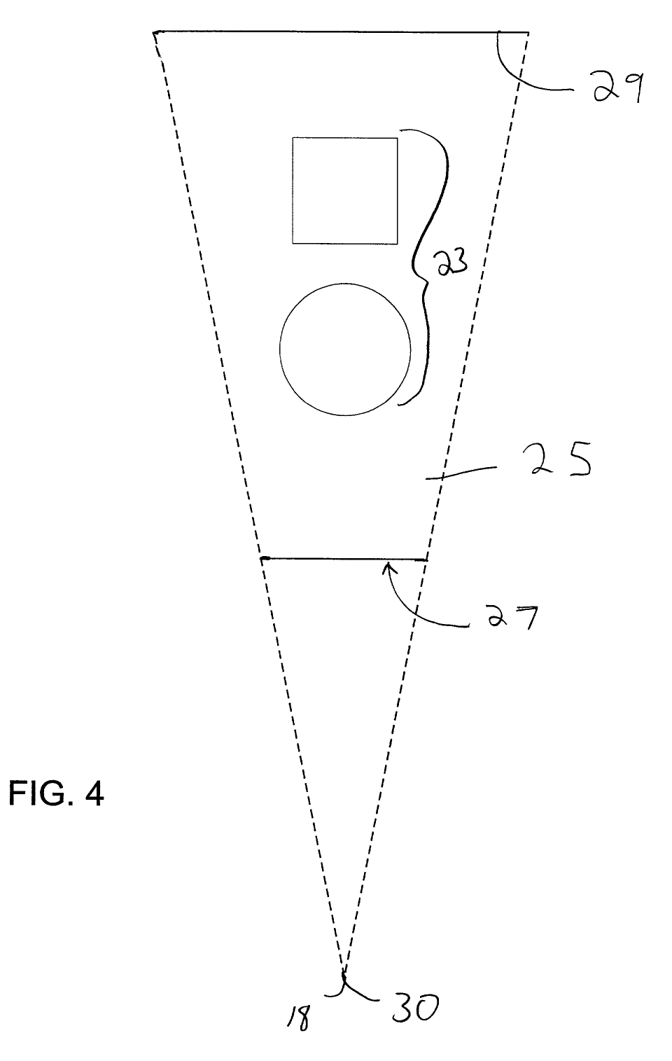

Referring to FIGS. 2-4, process 60 matches (61) a field of view angle 26 to a viewing angle 28 by moving a camera position 30 of 3D scene 22 to the same position as head 18 of user 16. A camera position is an imaginary position in a real-life world that a camera would be located to generate 3D scene 22. 3D scene 22 is rendered in a perspective projection defined by a frustum 25 bounded by a near plane 27 and on an opposite side by a far plane 29. Near plane 27 is a window through which user 16 observes 3D scene 22. For example, near plane 27 can be the entire size of display 24 (e.g., an entire computer screen) or a smaller 3D window depending on a user's preferences or software limitations. Field of view angle 26 is formed by extending two sides 32a and 32b of frustum 25 from near plane 27 until each side intersects at a vertex. Viewing angle 28 is formed by extending two lines 36a and 36b from head 18 of user 16 to side ends 34a and 34b of near plane 27. In another words, viewing angle 28 is equal to:

2arc tan(L/(2D )),

where is L is a length 31 of near plane 27 and D is a distance 33 from the user's eyes at point 18 to near plane 27.

When the field of view angle 26 and viewing angle 28 do not match (i.e., camera position 30 and head 18 do not appear to be in the same location), user 16 may not easily perceive 3D scene 22 as a 3D scene. However, by matching field of view angle 26 with viewing angle 28, user 16 can view 3D scene 22 with little difficulty.

Process 60 determines where to position camera position 30 by determining the location of head 18. In this embodiment, process 60 uses head position tracker 14 to detect the position of head 18 by detecting an iridescent color in headband 20. Headband 20 is placed on a user's forehead to give a close approximation of the position of user's eyes. Thus, process 60 matches (61) field of view angle 26 and viewing angle 28 by moving camera position 30 to the position of headband 20. In effect, the length of far plane 29 and sides 32a and 32b of frustum 25 are adjusted to change camera position 30.

Process 60 tracks (62) the movement of head 18 by following the movement of the iridescent color in headband 20. Based on these movements, process 60 uses these movements to transform (64) 3D scene 22 and to project (66) 3D scene onto display 24. Process 60 performs a transformation based on where head 18 moves. In this context, “transformation” of the 3D scene can refer to any shifting, rotation or magnification of the 3D scene. For example, when head 18 moves in a left direction, 3D scene 22 shifts in a right direction. Likewise, 3D scene 22 shifts to the left direction when head 18 moves to the right direction. If head 18 moves in an upward direction, 3D scene 22 moves in a downward direction and visa versa. In effect, the transformation has the effect of giving user 16 the sense of peering out a real-life window. In other words, user 16 is able to observe objects just outside the user's visual range by leaning head 18 to the left or to the right or upward or downward.

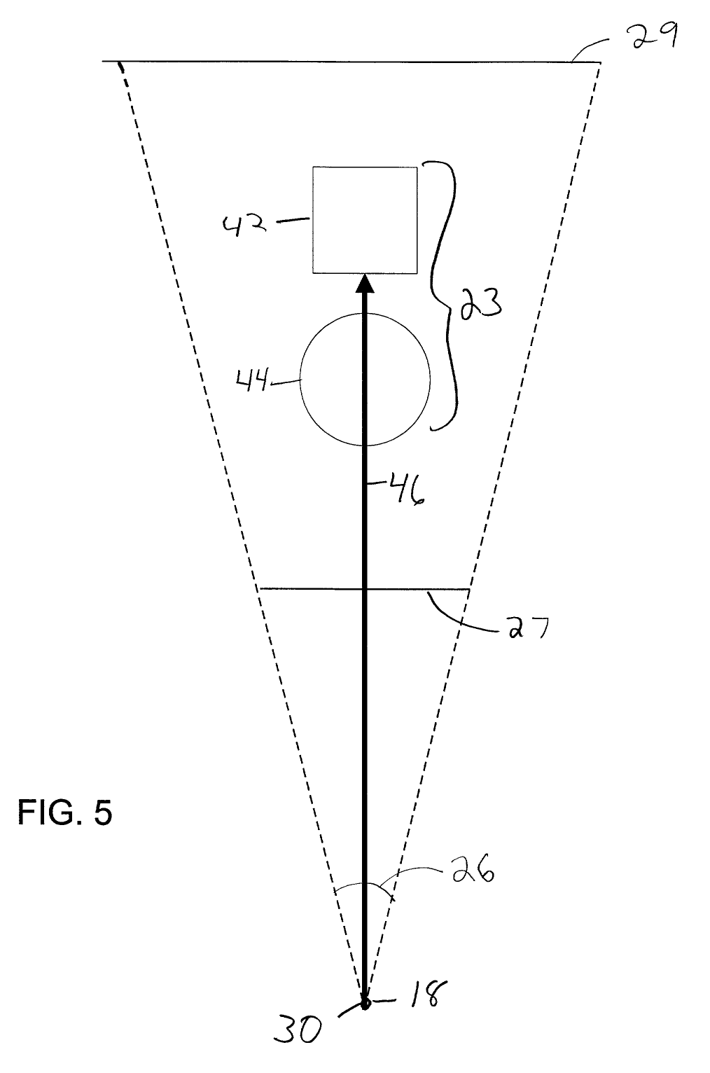

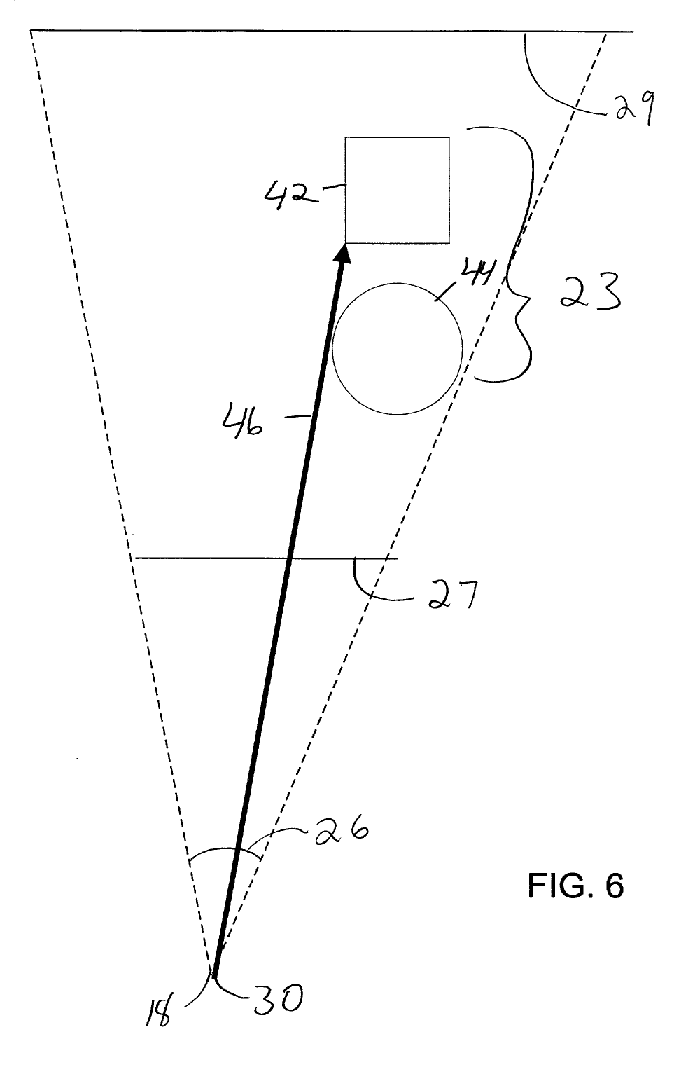

Referring to FIGS. 5 and 6, for example, a user 18 wishes to observe a cube 42. A line of sight 46 from user 18 to cube 42 is obscured by a sphere 44 (FIG. 5). When head 18 of user 16 leans to the left, user 16 is able to see cube 42 behind sphere 44 because line of sight 46 is no longer obscured (FIG. 6). In this embodiment, 3D scene 22 is moved with respect to head 18 by a factor of 10. For example, when head 18 moves 3 inches in the left direction, 3D scene 22 shifts 30 inches in the right direction.

Unlike what one observes when looking out a window, when user 16 leans forward towards display 24, scene 22 is magnified. When leaning backwards, scene 22 is expanded. Normally, when looking out a window, field of view angle 26 expands as one approaches a window. Likewise, as one steps backward and away from the window, field of view angle 26 contracts. In other embodiments, when user 16 leans forward towards display 24, field of view angle 26 expands as if user 16 was looking out a fish-eye lens so that objects 23 appear smaller.

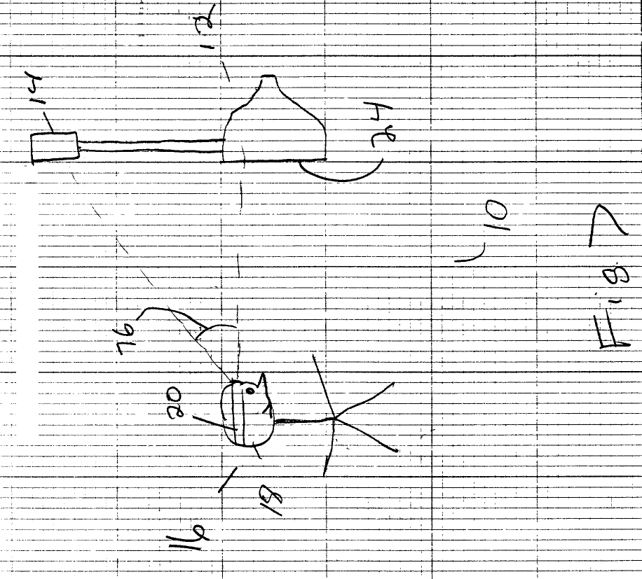

Referring to FIG. 7, in other embodiments, head position tracker 14 is placed above display 24 so that an angle 76 between head position tracker 14 and display 24 measured from head 18 is at least 30 degrees. The greater that angle 76 is, the easier head position tracker 14 can detect changes in motion.

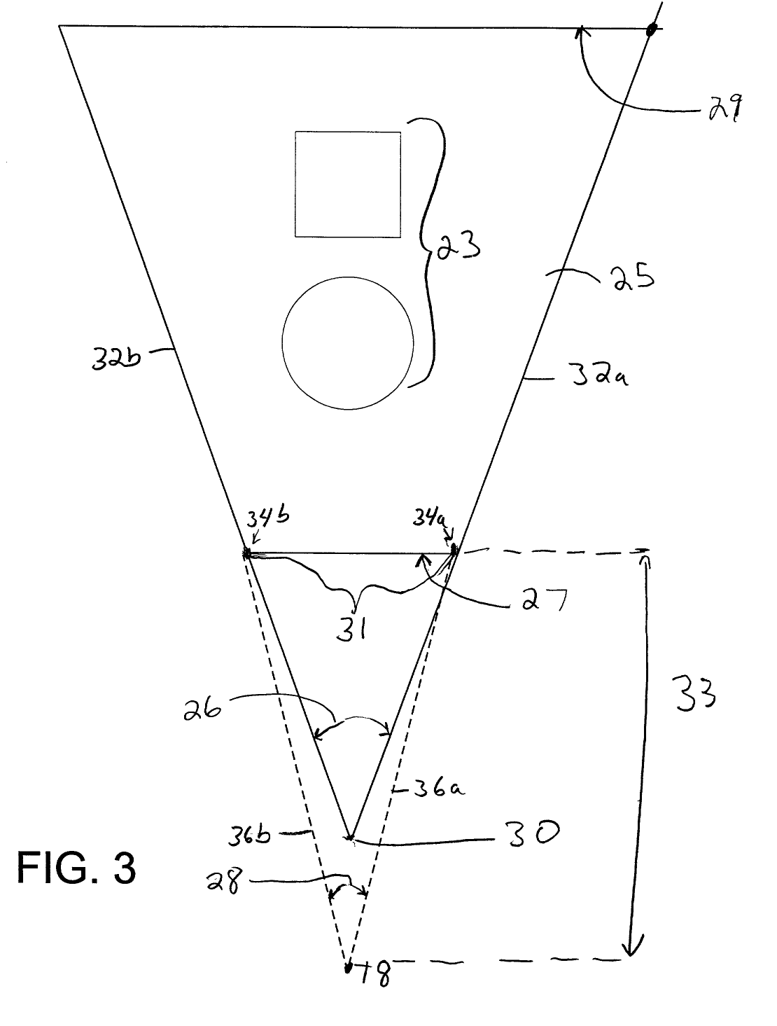

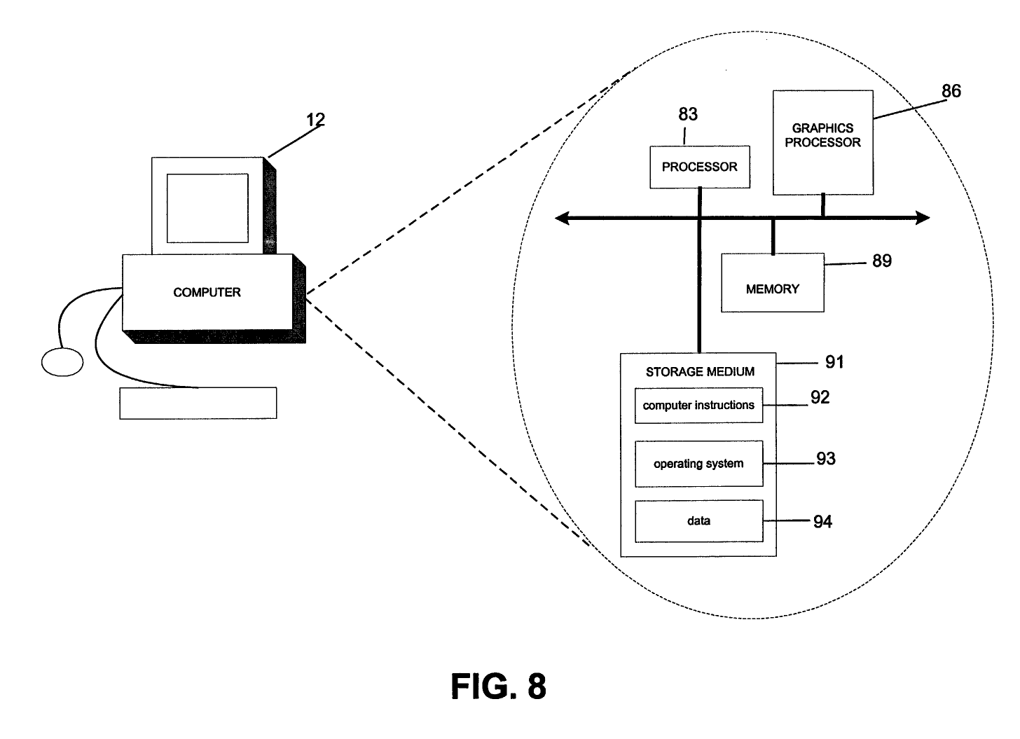

FIG. 8 shows a computer 12 for displaying a virtual three-dimensional (3D ) scene using process 60. Computer 12 includes a processor 83, a memory 89, a storage medium 91 (e.g., hard disk), and a 3D graphics processor 86 for processing data in the virtual 3D space of FIGS. 3 to 6. Storage medium 91 stores operating system 93, 3D data 94 which defines the 3D space, and computer instructions 92 which are executed by processor 83 out of memory 89 to perform process 60.

Process 60 is not limited to use with the hardware and software of FIG. 8; process 60 may find applicability in any computing or processing environment and with any type of machine that is capable of running a computer program. Process 60 may be implemented in hardware, software, or a combination of the two. Process 60 may be implemented in computer programs executed on programmable computers/machines that each include a processor, a storage medium/article of manufacture readable by the processor (including volatile and non-volatile memory and/or storage elements), at least one input device, and one or more output devices. Program code may be applied to data entered using an input device to perform process 60 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 60. Process 60 may also be implemented as a machine-readable storage medium, configured with a computer program, where upon execution, instructions in the computer program cause the computer to operate in accordance with process 60.

The invention is not limited to the specific embodiments described herein. For example, head position tracker 14 may track any portion of head 18 using any tracking method. For example, user 16 may wear a set of glasses that head position tracker 14 tracks, which may more accurately determine the position of the eyes. Also, head position tracker 14 can use other methods for tracking the eyes than headband 20. For example, head position tracker 14 could use radio waves (e.g., a radio frequency (RF) triangulation, ultrasonic transducer), infrared triangulation, a global positioning system, etc, which all could be used to track the positional changes of the user's eyes. Head position tracker 14 may be a face tracker. The face tracker takes a video image of a user's face as the face moves. The invention is also not limited for use in 3D space, but rather can be used in N-dimensional space (N≧3). The invention is not limited to the specific processing order of FIG. 2. Rather, the blocks of FIG. 2 may be re-ordered, as necessary, to achieve the results set forth above.

Other embodiments not described herein are also within the scope of the following claims.

What is claimed is:

1. A method of displaying a virtual three-dimensional (3D ) scene, comprising:
tracking a positional change of a head of a user with respect to a display;
transforming the virtual 3D scene in accordance with the positional change of the head; and
projecting on the display a transformed virtual 3D scene.

2. The method of claim 1, wherein transforming the virtual 3D scene comprises shifting the virtual 3D scene in a left direction of the user when the head moves in a right direction of the user.

3. The method of claim 2, wherein transforming the virtual 3D scene comprises shifting the virtual 3D scene in a right direction of the user when the head moves in a left direction of the user.

4. The method of claim 31 wherein the camera is attached to the display.

5. The method of claim 1, wherein transforming the virtual 3D scene comprises increasing a magnification of the virtual 3D scene when the head moves toward the display.

6. The method of claim 5, wherein transforming the virtual 3D scene comprises reducing the magnification of the virtual 3D scene when the head moves away from the display.

7. The method of claim 5, wherein the camera is positioned above the display.

8. The method of claim 3, wherein the virtual 3D scene is shifted with respect to the head by a factor of 10.

9. The method of claim 1, wherein tracking the positional change of the head further comprises tracking an iridescent color in an object attached to the head.

10. The method of claim 1, wherein transforming the virtual 3D scene comprises decreasing a magnification of the 3d scene when the head moves toward the display and increasing the magnification of the 3D scene when the head moves away from the display.

11. An apparatus for displaying a virtual three-dimensional (3D ) scene, comprising:
a memory that stores executable instructions; and
a processor that executes the instructions to:
track a positional change of a head of a user with respect to a display;
transform the virtual 3D scene in accordance with the positional change of the head; and
project on the display a transformed virtual 3D scene.

12. The apparatus of claim 11, wherein to transform the virtual 3D scene comprises to shift the virtual 3D scene in a left direction of the user when the head moves in a right direction of the user.

13. The apparatus of claim 12, wherein to transform the virtual 3D scene comprises to shift the virtual 3D scene in a right direction of the user when the head moves in a left direction of the user.

14. The apparatus of claim 13, wherein the camera is attached to the display.

15. The apparatus of claim 11, wherein transforming the virtual 3D scene comprises increasing a magnification of the virtual 3D scene when the head moves toward the display.

16. The apparatus of claim 15, wherein transforming the virtual 3D scene comprises reducing the magnification of the virtual 3D scene when the head moves away from the display.

17. The apparatus of claim 15, wherein the camera is positioned above the display.

18. The apparatus of claim 13, wherein the virtual 3D scene is shifted with respect to the head by a factor of 10.

19. The apparatus of claim 11, wherein to track the positional change of the head further comprises to track an iridescent color in an object attached to the head.

20. The apparatus of claim 11, wherein to transform the virtual 3D scene comprises to decrease a magnification of the 3d scene when the head moves toward the display and to increase the magnification of the 3D scene when the head moves away from the display.

21. An article comprising a machine-readable medium that stores executable instructions for displaying a virtual three-dimensional (3D ) scene, the instructions causing a machine to:
track a positional change of a head of a user with respect to a display;
transform the virtual 3D scene in accordance with the positional change of the head; and
project on the display a transformed virtual 3D scene.

22. The article of claim 21, wherein to transform the virtual 3D scene comprises to shift the virtual 3D scene in a left direction of the user when the head moves in a right direction of the user.

23. The article of claim 22, wherein to transform the virtual 3D scene comprises to shift the virtual 3D scene in a right direction of the user when the head moves in a left direction of the user.

24. The article of claim 23, wherein the camera is attached to the display.

25. The article of claim 21, wherein to transform the virtual 3D scene comprises to increase a magnification of the virtual 3D scene when the head moves toward the display.

26. The article of claim 25, wherein to transform the virtual 3D scene comprises to reduce the magnification of the virtual 3D scene when the head moves away from the display.

27. The article of claim 25, wherein the camera is positioned above the display.

28. The article of claim 23, wherein the virtual 3D scene is shifted with respect to the head by a factor of 10.

29. The article of claim 21, wherein to track the positional change of the head further comprises to track an iridescent color in an object attached to the head.

30. The article of claim 21, wherein to transform the virtual 3D scene comprises to decrease a magnification of the 3d scene when the head moves toward the display and to increase the magnification of the 3D scene when the head moves away from the display.
